(19) United States
(12) Patent Application Publication
(10) Pub. No.: US 2010/0169021 A1
(43) Pub. Date: Jul. 1, 2010

(54) Earthquake detection apparatus, system, and method

(75) Inventor: Martti Johannes Moisio, Haarajoki (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 12/318,578

(22) Filed: Dec. 31, 2008

(51) Int. Cl. G01V 1/28

(52) U.S. Cl. 702/15

(57) ABSTRACT

An apparatus, system, and method for a communication network that includes a wireless terminal and a central unit. The wireless terminal is configured to receive potential seismic data, analyze the potential seismic data, determine whether an occurrence of an actual seismic event is sufficiently probable, and generate a potential seismic event message configured to indicate a potential occurrence of a seismic event. The central unit is configured to receive the potential seismic event message from the wireless terminal, analyze the potential seismic event message, determine whether a seismic event has occurred, and generate a seismic event message.

### BACKGROUND

1. Related Field

The present invention relates generally to wireless communication networks. More specifically, the present invention relates to apparatuses, systems, and methods for detecting seismic events.

2. Description of the Related Art

The pervasiveness of wireless communication networks throughout the world continues to increase in a variety of ways. For example, wireless communication networks are continuously being introduced into relatively remote geographical areas. Additionally, as a population in a given area increases, the use of mobile phones and wireless technology often increases as well. Though currently available wireless technologies provide a practical and cost effective solution for enabling communication amongst users, currently available technologies fail to provide for other issues as well. For example, currently available wireless communication networks fail to provide solutions for detecting and reporting natural disasters such as earthquakes.

### SUMMARY

The present invention has been developed in response to the present state of the art, and in particular, in response to the problems and needs in the art that have not yet been fully solved by currently available communication system technologies. Accordingly, the present invention has been developed to enable an earthquake detection apparatus, system, and method.

In one embodiment of the present invention, a method comprises receiving potential seismic data, analyzing the potential seismic data, determining whether an occurrence of an actual seismic event is sufficiently probable, and generating a potential seismic event message configured to indicate a potential occurrence of a seismic event. In certain embodiments, the generating of the potential seismic event message to be transmitted to a mobile communication network.

In some embodiments, the generating of the potential seismic event comprises generating a reduced requirement message. The generating of the reduced requirement message may also comprise generating a message that requires a reduced amount of bandwidth to be transmitted to the mobile communication network. In certain embodiments, the method may also include entering a discontinuous monitoring mode, determining whether a first trigger has been activated, exiting the discontinuous monitoring mode and entering a active monitoring mode when the first trigger has been activated, determining while active monitoring mode is on whether a second trigger has been activated, exiting the active monitoring mode and entering the discontinuous monitoring mode. The operations performed during the active monitoring mode may be more resource-intensive than operations performed during the discontinuous monitoring mode.

In some embodiments, the generating of the potential seismic event message comprises indicating at least one characteristic of the potential occurrence of the seismic event. In certain embodiments, the potential seismic data is generated locally in response to sensing potential seismic activity. In some embodiments, the determining of whether a potential seismic event has occurred comprises comparing the potential seismic data with example seismic data.

In certain embodiments, the potential seismic event message is configured to be transmitted to a mobile communication network. Additionally, in some embodiments, the potential seismic event message is configured to be transmitted according to a high priority status. In some embodiments, the generating of the potential seismic event message may include executing error detection and correction operations to ensure the seismic event message is accurate.

In some embodiments, the method may include initiating a reception confirmation interval, determining whether a reception confirmation message has been received, determining whether the reception confirmation interval has expired, and regenerating the potential seismic activity message when the reception confirmation message has not been received before the reception confirmation interval has expired. In certain embodiments, the method may include initiating a new message interval, after expiration of a pre-selected interval, receiving additional seismic data, analyzing the additional seismic data, and generating an additional potential seismic event message.

In another embodiment of the present invention, an apparatus comprises a processor configured to receive potential seismic data, analyze the potential seismic data, determine whether an occurrence of an actual seismic event is sufficiently probable, and generate a potential seismic event message configured to indicate a potential occurrence of a seismic event. In certain embodiments, the processor is configured to generate the potential seismic event message to be transmitted to a mobile communication network.

In certain embodiments, the reduced requirement message comprises a message that requires a reduced amount of bandwidth to be transmitted to the mobile communication network. In some embodiments, the reduced requirement message comprises a message generated using a reduced amount of battery usage. The processor may further be configured to enter into a discontinuous monitoring mode, determine whether a first trigger has been activated, exit the discontinuous monitoring mode and entering a active monitoring mode when the first trigger has been activated, determine whether a second trigger has been activated, exiting the active monitoring mode and entering the discontinuous monitoring mode when the second trigger has been activated.

In some embodiments, the processor is configured to generate the potential seismic event message by indicating at least one characteristic of the potential occurrence of the seismic event. The potential seismic data may be generated locally in response to sensing potential seismic activity. Additionally, the potential seismic data may be generated locally by a seismic event sensor.

In certain embodiments, the processor is configured to determine whether a potential seismic event has occurred by comparing the seismic data with example seismic data. In some embodiments, the potential seismic event message is configured to be transmitted to a mobile communication network. Additionally, the potential seismic event message may be configured to be transmitted according to a high priority status. In certain embodiments, the processor is further configured to execute an error detection and correction operation with respect to the potential seismic event message.

In some embodiments, the processor is configured to initiate a reception confirmation interval, determine whether a reception confirmation message has been received, determine whether the reception confirmation interval has expired, and regenerate the potential seismic activity message when the reception confirmation message has not been received before the reception confirmation interval has expired. In certain embodiments, the processor is configured to receive additional seismic data, analyze the additional seismic data, and generate an additional potential seismic event message, after expiration of a pre-selected interval.

In another embodiment of the present invention, a computer program is embodied on a computer-readable medium. The computer program may be configured to control a processor to perform operations that comprise receiving potential seismic data, analyzing the potential seismic data, determining whether an occurrence of an actual seismic event is sufficiently probable, and generating a potential seismic event message to be transmitted to a mobile communication network.

In yet another embodiment of the present invention, an apparatus may comprise receiving means for receiving seismic data from a local sensor unit, analyzing means for analyzing the potential seismic data, determining means for determining whether a potential seismic event has occurred by analyzing the seismic data, and generating means for generating a potential seismic event message to be transmitted to a mobile communication network.

In another embodiment of the present invention, a method comprises receiving a potential seismic event message from a wireless terminal, analyzing the potential seismic event message, determining whether a seismic event has occurred, and generating a seismic event message. In certain embodiments, the seismic event message is transmitted to the wireless terminal and to an earthquake and tsunami warning system. In some embodiments, the receiving of the potential seismic event message occurs in response to the wireless terminal sensing the seismic event. In certain embodiments, the analyzing of the seismic event message comprises comparing the potential seismic event message to a potential seismic event message received from another wireless terminal.

In another embodiment of the present invention, an apparatus comprises a processor configured to receive a potential seismic event message from a wireless terminal, analyze the potential seismic event message, determine whether a seismic event has occurred, and generate a seismic event message.

In certain embodiments, the seismic event message is transmitted to the wireless terminal and to an earthquake and tsunami warning system. In some embodiments, the processor is configured to receive the potential seismic event message in response to the wireless terminal sensing the seismic event. In certain embodiments, the processor is configured to analyze the potential seismic event message by comparing the seismic event message to a potential seismic event message received from another wireless terminal.

In another embodiment of the present invention, a computer program is embodied on a computer-readable medium. The computer program may be configured to control a processor to perform operations that include receiving a potential seismic event message from a wireless terminal, analyzing the potential seismic event message, determining whether a seismic event has occurred, and generating a seismic event message.

In yet another embodiment of the present invention, an apparatus may comprise receiving means for receiving a potential seismic event message from a wireless terminal, analyzing means for analyzing the potential seismic event message, determining means for determining whether a seismic event has occurred, and generating means for generating a seismic event message.

In another embodiment of the present invention, a system may comprise a wireless terminal configured to receive potential seismic data, analyze the potential seismic data, determine whether an occurrence of an actual seismic event is sufficiently probable, and generate a potential seismic event message configured to indicate a potential occurrence of a seismic event. The system may also comprise a central unit configured to receive the potential seismic event message from the wireless terminal, analyze the potential seismic event message, determine whether a seismic event has occurred, and generate a seismic event message.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram of an earthquake detection system in accordance with one embodiment of the present invention;

FIG. 2 is a block diagram of a wireless terminal in accordance with one embodiment of the present invention;

FIG. 3 is a block diagram of a central unit in accordance with one embodiment of the present invention;

FIG. 4 is a flow chart diagram of a method for a wireless terminal generating potential seismic data in accordance with one embodiment of the present invention;

FIG. 5 is a flow chart diagram of a method for a wireless terminal generating a potential seismic event message in accordance with one embodiment of the present invention;

FIG. 6 is a flow chart diagram of a method for a wireless terminal generating an additional potential seismic event message in accordance with one embodiment of the present invention;

FIG. 7 is a flow chart diagram of a method for a wireless terminal confirming reception of a potential seismic event message in accordance with one embodiment of the present invention;

FIG. 8 is a flow chart diagram of a method for a wireless terminal conserving battery power in accordance with one embodiment of the present invention;

FIG. 9 is a flow chart diagram of a method for a central unit detecting a seismic event in accordance with one embodiment of the present invention; and

FIG. 10 is a sequence flow diagram of a method for detecting a seismic event in accordance with one embodiment of the present invention.

### DETAILED DESCRIPTION OF THE PREFERRED EMBODIMENT(S)

It will be readily understood that the components of the present invention, as generally described and illustrated in the figures herein, may be arranged and designed in a wide variety of different configurations. Thus, the following more detailed description of the embodiments of the apparatus, system, and method of the present invention, as represented in the attached figures, is not intended to limit the scope of the invention, as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

In addition, while the terms, data, packet, and/or datagram have been used in the description of the present invention, the invention has import to many types of network data. For purposes of this invention, the term data includes packet, cell, frame, datagram, bridge protocol data unit packet, packet data and any equivalents thereof.

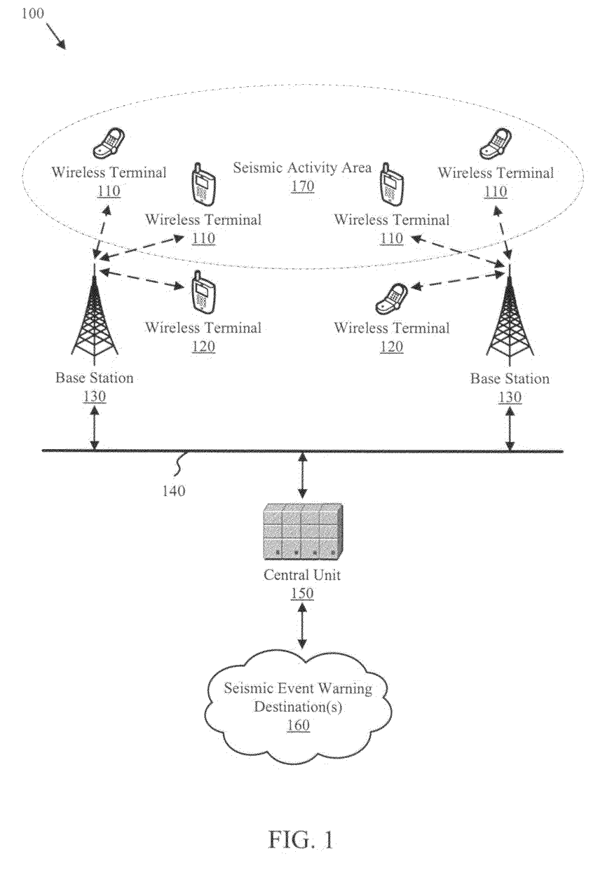

FIG. 1 is a block diagram of an earthquake detection system 100 in accordance with one embodiment of the present invention. The depicted system 100 includes wireless terminals 110 and 120, base stations 130, a mobile communication network backbone 140, a central unit 150, and earthquake warning destinations 160. The components of the system 100 may operate to detect and report seismic events.

In certain embodiments, the wireless terminals 110 are configured to sense or detect potential seismic activity corresponding to a seismic activity area 170. Seismic activity may include a sudden release of energy from the Earth's crust that results in seismic waves or earthquakes. In some embodiments, each of the wireless terminals 110 produce potential seismic data in response to sensing or detecting the potential seismic activity. The wireless terminals 110 may analyze the potential seismic data to determine whether the occurrence of an actual seismic event is sufficiently probable.

In some embodiments, the wireless terminals 110 may communicate a potential seismic event message to the central unit 150 if the wireless terminals 110 determine that it is sufficiently probably that an actual seismic event has occurred. As depicted, a potential seismic event message may be communicated via the base stations 130 and the network backbone 140. In some embodiments, the central unit 150 may receive potential seismic event messages from the wireless terminals 110. A potential seismic event message may include any data relevant or useful to the detection and reporting (or warning) of seismic events. For example, a potential seismic event message may include data describing the seismic activity detected, the wireless terminal sending the message, or conditions under which the message is being sent.

In certain embodiments, the central unit 150 may analyze the potential seismic event messages to determine whether an actual seismic event, such as an earthquake, has occurred. In some embodiments, if a seismic event has occurred, the central unit 150 may generate and transmit seismic event warning messages to the wireless terminals 110 and 120, in addition to seismic event warning destinations such as natural disaster warning systems or other emergency warning systems. Accordingly, the components of the system 100 may cooperate to provide an effective solution for detecting seismic events.

It should be appreciated that the system 100 may be embodied using a wide variety of technologies. For example, the system 100 may operate in accordance with wireless and cellular standards such as Global System for Mobile Communications (GSM) and Universal Mobile Telecommunications Systems (UMTS). Additionally, the system may be embodied using 3^{rd} Generation Partnership Project (3GPP) Long Term Evolution (LTE) technologies and International Telecommunication Union (ITU) technologies such as the International Mobile Telecommunications Advanced (IMT-A) standard. Accordingly, a system 100 of the present invention may be applied to a wide variety of mobile communication systems and may include additional network nodes and components germane to communication networks known to those skilled in the art.

Additionally, it should be appreciated that a system of the present invention may naturally scale according to need. For example, as a population in a given area increases, so does the need for a robust, accurate, efficient, and cost effective solution for detecting and warning against seismic events. Similarly, an increase in population often results in a relative increase in the number of wireless terminals in the area, which may each operate to detect and report potential seismic activity. Consequently, the system 100 of the present invention provides a solution for detecting and warning against seismic events that naturally and efficiently scales with the need for sensing seismic activity.

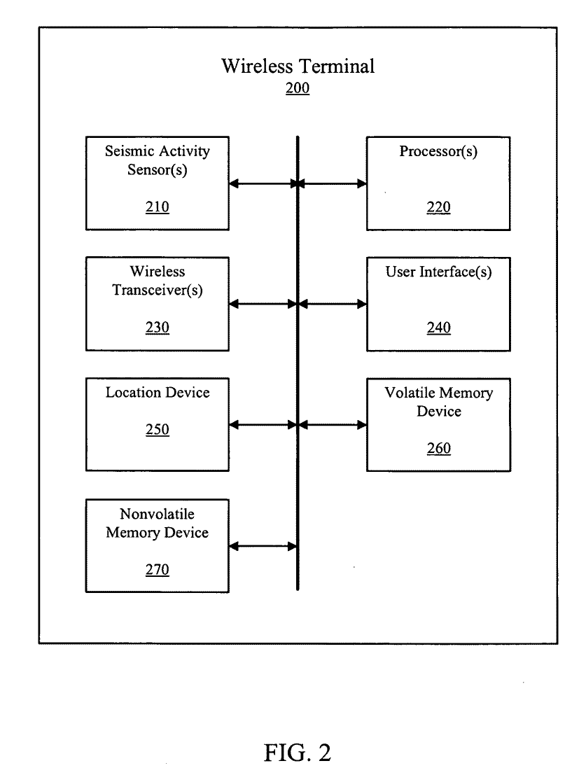

FIG. 2 is a block diagram of a wireless terminal 200 in accordance with one embodiment of the present invention. The depicted wireless terminal 200 includes a seismic activity sensor 210, a processor 220, a wireless transceiver 230, a user interface 240, location device 250, and a volatile memory device 260, and a nonvolatile memory device 270. In certain embodiments, the wireless terminal 200 may correspond to the wireless terminals 110 and/or 120 of FIG. 1. Additionally, the wireless terminal 200 may be embodied as a variety of devices known to those skilled in the art. Such devices may include wireless mobile terminals, such as cellular telephones and smart phones, or wireless fixed terminals. As will be discussed in greater detail below, the components of the wireless device may cooperate to facilitate the detection of seismic events.

In certain embodiments, the seismic activity sensor 210 may be configured to sense seismic activity. In some embodiments, the seismic activity sensor 210 may be a variety of devices, such as an accelerometer, a seismometer, or other device configured to sense or detect seismic waves and/or vibration. Accordingly, as the present invention provides for a wireless terminal 200 configured to sense seismic activity, the present invention provides a seismic activity sensing capacity over a geographic area that is commensurate with a population density of the of the geographic area.

In certain embodiments, the seismic activity sensor 210 is configured to generate potential seismic data representing the potential seismic activity sensed or detected. Potential seismic data may include any data that would enhance the accuracy of detecting a seismic event. For example, the potential seismic data may include data representing a wave frequency, a wave amplitude, a wavelength, or other characteristic of the potential seismic activity sensed.

In certain embodiments, the wireless terminal 200 is configured to operate in accordance with one or more monitoring modes or modes of operation. A monitoring mode may include one or more rules or constraints by which a device, such as a processor of a wireless terminal, must operate or function. One such monitoring mode may include an active monitoring mode (AMM). AMM may be a mode of operation for performing one or more seismic event detection operations. For example, AMM may cover operations for analyzing potential seismic event data to determine whether an occurrence of a potential seismic event is sufficiently probable. Additionally, AMM may be a continuous monitoring mode or a mode of continuous monitoring. Accordingly, in some embodiments, the wireless terminal 200 may be configured to enter into a monitoring mode that is specified for the performance of one or more seismic event detection operations.

Another monitoring mode may include a discontinuous monitoring mode (DMM). A DMM may involve a mode of operation where one or more seismic event detection operations are not performed. In some embodiments, DMM may include only performing preliminary seismic event detection operations. For example, DMM may only include an operation such as detecting seismic activity or detecting seismic activity coupled with generating potential seismic event data.

In some embodiments, DMM does not include more resource-intensive operations such as analyzing potential seismic event data to determine whether a seismic event has occurred. In certain embodiments, the wireless terminal 200 may enter into DMM during times of little or no seismic activity, which may enable power conservation and/or extended battery “life” by discontinuing unnecessary operations. Accordingly, in some embodiments, DMM may include a “power save” or “sleep” mode for one or more potential seismic event data analysis operations.

In certain embodiments, the wireless terminal 200 may be configured to shift between monitoring modes depending upon a detected condition or trigger. For example, the wireless terminal 200 may be configured to operate in DMM when little or no seismic activity is being detected. As mentioned above, in certain embodiments, operating in DMM enables power conservation, resulting in an extended battery life.

Additionally, the wireless terminal 200 may be configured to transition to AMM upon the activation of a first trigger. The first trigger may correspond to a variety of conditions or scenarios. In certain embodiments, the first trigger may involve a seismic activity sensor 210 detecting seismic activity that satisfies or exceeds a pre-selected threshold (i.e., an acceleration beyond that which has been designated as normal). Upon activation of the first trigger, wireless terminal 200 may commence operating according to AMM. As discussed previously, AMM may enable the wireless terminal 200 to perform one or more seismic detection operations such as analyzing potential seismic event data.

The wireless terminal 200 may also be configured to revert back to DMM in response to the activation of a second trigger. Similar to the first trigger, the second trigger may correspond to a variety of conditions or scenarios. In certain embodiments, the second trigger may include a scenario where seismic activity has not been detected within a pre-selected time interval, which suggests that AMM is no longer necessary. As a result of reverting back DMM, the wireless terminal 200 may return to conserving power.

Accordingly, the wireless terminal 200 may be configured to use a relatively smaller amount of battery power to perform a preliminary detection, and thereafter transition to a more thorough analysis mode that consumes more battery power and processor capacity, but provides a more complete analysis of the seismic activity. In other words, the wireless terminal 200 may be configured to operate in one or more monitoring modes in order to conserve power by judiciously performing operations when such operations are warranted. It should be appreciated that the foregoing description of modes may be performed by the processor 220 or a combination of the processor 220 and other components of the wireless terminal 200.

In certain embodiments, the processor 220 may be configured to receive or obtain potential seismic data from the seismic activity sensor 210. The processor 220 may also analyze the potential seismic data to determine whether the occurrence of an actual seismic event is sufficiently probable. In certain embodiments, analysis of the potential seismic data may include one or more statistical operations and/or statistical determinations. Accordingly, processor 220 of the present invention may perform a variety of analytical operations to enhance the efficiency and accuracy of a seismic activity detection and reporting system.

In some embodiments, analysis of the seismic data may include operations such as comparing the seismic data to example seismic data that is stored in the volatile memory device 250 and/or nonvolatile memory device 270. Example seismic data may include data representative of one or more actual seismic events and/or data representative of one or more simulated seismic events. Accordingly, the processor 220 of the present invention may enhance the accuracy and efficiency of a seismic event detection and reporting system by using up-to-date data that represents actual seismic events.

In some embodiments, analysis of the seismic data may include evaluating the potential seismic data in light of previously analyzed data and previous analyses. For example, if a user were running to a bus stop while carrying to wireless terminal 200, the seismic activity sensor 210 may have several vibration intervals which were each appropriately interpreted by the processor 220 as non-seismic events. However, upon reaching the bus stop, the user may accidentally drop the wireless terminal 200 in such a way that causes the seismic activity sensor 210 to generate data that is similar to an actual seismic event. In such a scenario, the processor 220 may consider the recent data of the non-seismic events in determining the likelihood that the “drop” seismic data represents an actual seismic event.

In another example, a user may be located in an actual seismic activity area and the processor 220 may have already analyzed several vibration intervals similar to actual seismic activity. In such a scenario, the processor 220 may be configured to consider the previously analyzed seismic data, and/or the analyses thereof, when analyzing the most recent seismic data set. Accordingly, in some embodiments, the processor 220 may improve the accuracy of determining whether an actual seismic event is sufficiently probable by considering previously analyzed data and/or previous analyses.

Additionally, the processor 220 may be configured to follow one or more pre-selected rules when considering previously analyzed data or previous analyses. For example, the processor 220 may only consider previously analyzed data if the data sufficiently relevant. In embodiments, relevancy may be ascertained by determining whether previously analyzed data of analyses have become too “old.” Accordingly, in certain embodiments, the processor 220 may improve the accuracy of determining whether an actual seismic event is sufficiently possible by configuring the processor 220 to follow one or more pre-selected rules when considering previously analyzed data and/or previous analyses.

Furthermore, the processor 220 may be configured to consider additional data when determining a probability that the seismic activity sensed by the seismic activity sensor 210 corresponds to an actual seismic event. Such data may include data regarding the operations performed by the wireless terminal 200 at or near the time that the seismic activity was sensed. For example, while analyzing the seismic data, the processor 220 may consider data of whether a vibration ring tone operation was recently executed by the user interface 240. In addition to increasing accuracy, configuring the processor to consider additional data may enable the processor 220 to operate expeditiously as, in the case of the vibrating ring tone, the processor 220 may be able to quickly conclude that there is no seismic event, and thereby forego more resource-intensive analysis operation such as a Monte Carlo Simulation or the like.

In another example, the processor 220 may consider whether the wireless terminal 200 was performing operations consistent with a user inputting data by, for example, pressing user interface buttons or connecting the wireless terminal 200 to one or more external devices (not shown). In yet another example, the processor 220 may consider whether operations corresponding to a video game were being performed such as making the user interface 240 vibrate in order to enhance the game play experience, or perhaps a series of game operations that require the user repeatedly or frantically press one or more user interface buttons. Accordingly, configuring the processor 220 to consider additional sources of data may enable the processor 220 to operate with greater efficiency and accuracy.

In addition to analyzing seismic data generated by the seismic activity sensor 210, the processor 220 may be configured to determine whether the occurrence of an actual seismic event is sufficiently probable. In certain embodiments, “sufficiently probable” may correspond to satisfying or exceeding a pre-selected confidence level or threshold. In some embodiments, the processor 220 may be configured to store and/or ignore the data associated with the seismic activity if the processor 220 determines that an actual seismic event is not sufficiently probable. Accordingly, the processor 220 may act as a filter by identifying and dispatching of false positives.

However, in certain embodiments, the processor 220 may be configured to generate a potential seismic event message if the processor 220 determines that an actual seismic event is sufficiently probable. A potential seismic event message in accordance with the present invention may include a wide variety of data and may include a reduced requirement message such as a POSSIBLE_EARTHQUAKE_DETECTION (PED) message configured to require a reduced amount of bandwidth. In certain embodiments, a potential seismic event message may be a smaller message, such as a single-bite message of “true.” Accordingly, a reduced requirement message may include a message that requires a minimum or reduced amount battery power (or usage) to generate and/or a minimum or reduced amount of bandwidth to transmit.

In other embodiments, a potential seismic event message may be a relatively large and include data in addition to or distinct from the smaller embodiments of a potential seismic event message. Indeed, a larger potential seismic event message may include data descriptive of the potential seismic event, descriptive of the wireless terminal 200, the circumstances of the wireless terminal 200, or other data accessible to the wireless terminal 200. Accordingly, a potential seismic event message of the present invention may include a variety of data.

For example, in certain embodiments, information contained in a potential seismic event message may be represented by the following.

PED Message {
<5 bits> Detection Probability/Strength
<32 bits> GPS Location
}

As indicated by the foregoing example, a potential seismic event message may include an indication of a detection probability and/or strength as well as location data corresponding to the geographical location wireless terminal 200. In such embodiments, the processor 220 may cooperate with the location device 260 to obtain data of an exact or estimated location of the wireless terminal 200. Additionally, though the location data in the example above is presented as having the precision of GPS technology, location data may only correspond to a general location of the wireless terminal 200. In some embodiments, subsequent potential seismic activity messages may include location data if the wireless terminal 200 determines that a distance between a previous potential seismic event message and a current potential seismic event message is greater than a pre-selected threshold.

In some embodiments, the processor 220 may be configured to initiate a new message time interval upon generating a potential seismic event message. A new message time interval may comprise a temporal duration such as 100 milliseconds (ms). In some embodiments, the temporal duration may be pre-selected and/or dynamically determined depending upon one or more conditions under which the wireless terminal 200 is operating.

In certain embodiments, the processor 220 may be configured to postpone one or more or subsequent operations until the new message time interval has expired. In other embodiments, the processor 220 is not required to postpone the performance of subsequent operations. In certain embodiments, the processor 220 may be configured to dynamically switch between postponing and not postponing one or more operations for generating additional potential seismic event messages depending on one or more conditions. Accordingly, a processor 220 of some embodiments of the present invention may be flexible in the temporal spacing of seismic event operations to, for example, conserve power and/or adhere to one or more communication standards or protocols.

Similar to the new message interval discussed above, the processor 220 may be configured to initiate a reception confirmation interval. A reception confirmation interval reception may comprise a temporal duration. In certain embodiments, the temporal duration may be pre-selected temporal duration, and the reception confirmation interval may correspond to an Automatic Repeat request (ARQ) operation. In some embodiments, the temporal duration may be pre-selected and/or dynamically determined depending upon one or more conditions under which the wireless terminal 200 is operating.

In certain embodiments, the processor 220 may be configured to determine postpone the performance of subsequent operations until after the reception confirmation interval has expired. In other embodiments, the processor 220 is not required to postpone subsequent operations. In certain embodiments, the processor 220 may be configured to dynamically determine whether to postpone the performance of subsequent operations depending on the existence of one or more conditions.

For example, in certain embodiments, the processor 220 may be configured to proceed with subsequent operations if a reception confirmation message is received before a pending confirmation interval has expired. Accordingly, the present invention provides configurations that a processor 220 may have in order to achieve the particular objectives of a given seismic event detection and warning system. Indeed, in certain embodiments, the processor 220 may be configured to use both the new message interval and the and reception confirmation interval mentioned above.

In some embodiments, the processor 220 and the wireless transceiver 230 may be configured to communicate with a wireless access point, such as a base station of a mobile communication network (not shown). For example, in certain embodiments, the wireless transceiver 230 may be configured transmit a potential seismic event message generated by the processor 220 to the central unit of a mobile telecommunications network. Additionally, in some embodiments, the wireless transceiver 230 may be configured to receive one or more reception confirmation messages from a mobile communication network.

It should be appreciated that the wireless transceiver 230 may be embodied by any communication device fit for performing operations assigned thereto. In certain embodiments, the wireless transceiver 230 may be configured to communicate using a variety of communication protocols and/or standards. Indeed, the wireless transceiver 230 may be a device configured to operate in a manner that is consistent with GSM and UMTS standards, in addition to LTE and ITU technologies. Additionally, in some embodiments, the wireless transceiver 230 may include a combination of hardware and software, in addition to an antenna system. Accordingly, embodiments of the wireless transceiver 230 may facilitate the detection of seismic event detection by enabling the wireless terminal 200 to communicate with a mobile communication system.

In certain embodiments, the user interface 240 may include a combination of hardware and software that facilitates communication between the wireless terminal and a user of the wireless terminal 200. For example, a user interface 240 may include one or more speakers, one or more vibration devices, one or more user-pressable buttons, one or more key pads, one or more digital screens, one or more lights, or any other feature that would facilitate bidirectional communication between the wireless terminal and a user. In certain embodiments, the user interface 240 may be configured to perform or produce a variety of sounds, vibrations, graphics, lights, or any combination thereof to facilitate communication between the wireless terminal 200 and the user. In some embodiments, a digital screen of the user interface 240 may be responsive to a device used by the user, such as a digital pen, or to an appendage of the user, such as one or more user fingers.

In certain embodiments, a microphone of the user interface 240 may be configured to sense audio inputs and generate digital data corresponding thereto. As will be discussed in greater detail below, the user interface 240 may be configured to enable the wireless terminal 200 to communicate a seismic event warning received from a central unit to a user. Additionally, the user interface 240 may be configured to cooperate with one or more internal components, such as the processor 220 and memory 250, or external devices, such as a personal computer, to facilitate wireless terminal operations. Accordingly, a user interface 240 of the present invention may increase the value and utility by enabling communication between a user and the wireless terminal 200.

As discussed above, the location device 250 may be configured to provide data as to a geographical location of the wireless terminal 200. In certain embodiments, the certain embodiments, the location device 250 may include a GPS device configured to generate data of a precise geographical location of the wireless terminal 200. In other embodiments, the location device 250 may be configured to generate data of a general or estimated geographic location of the wireless device.

In certain embodiments, data of a general or estimated location may be based on a relationship of the wireless terminal with respect to one or more base stations of a mobile communication network. In some embodiments, the location device 250 may be configured to generate or obtain location data by performing one or more operations in accordance with standards and/or protocols known to those skilled in the art. Generating data representing a location of the wireless terminal 200 may enhance seismic event detection because a central unit receiving the location data might better determine whether an actual seismic event has occurred and a geographical location where the seismic event was detected.

In some embodiments, the volatile memory device 260 may include any variety of volatile storage mediums. For example, the volatile memory device 260 may include a device comprising a volatile storage component, a primary storage component, a random access memory (RAM) component, and/or a dynamic random access memory (DRAM) component such as a double data rate synchronous dynamic access memory (DDR SDRAM) component. Accordingly, the volatile memory device 260 may provide a temporary data storage structure that functionally interacts with other components, such as the processor 220 and the nonvolatile storage device 270, to facilitate seismic event detection operations and enhance the overall utility and performance of the wireless terminal.

In certain embodiments, the nonvolatile memory device 270 may include a variety of nonvolatile storage mediums. For example, the nonvolatile memory device 270 may include any variety of a read-only memory (ROM) components such as a programmable read-only memory (PROM), a field programmable read-only memory (FPROM), an erasable programmable read-only memory (EPROM), or an electrically erasable programmable read-only memory (EEPROM). Examples of the nonvolatile memory device 270 may also include optical memory components such as an optical disk. Additionally, the nonvolatile storage device 270 may store seismic activity data, previous analyses of seismic activity data, confidence level data, copies of potential seismic event messages, location data, copies of reception confirmation message, previously received seismic event warning messages, and data corresponding to one or more protocols. Accordingly, the nonvolatile memory device 270 may be configured to functionally interact with other wireless terminal components, such as the processor 220, to enable and/or facilitate seismic event detection as described herein.

A computer program embodied on a computer-readable medium, a compute-readable medium encoded with a computer program, or similar language may be embodied as a tangible data storage device storing computer software programs configured to control a processor to perform one or more operations. A tangible data storage device may be embodied as a volatile memory device or a nonvolatile memory device, and/or a combination of the volatile memory device and the nonvolatile memory device. Accordingly, the present invention provides for a computer-readable medium encoded with a computer program, where the computer program is configured to perform operations.

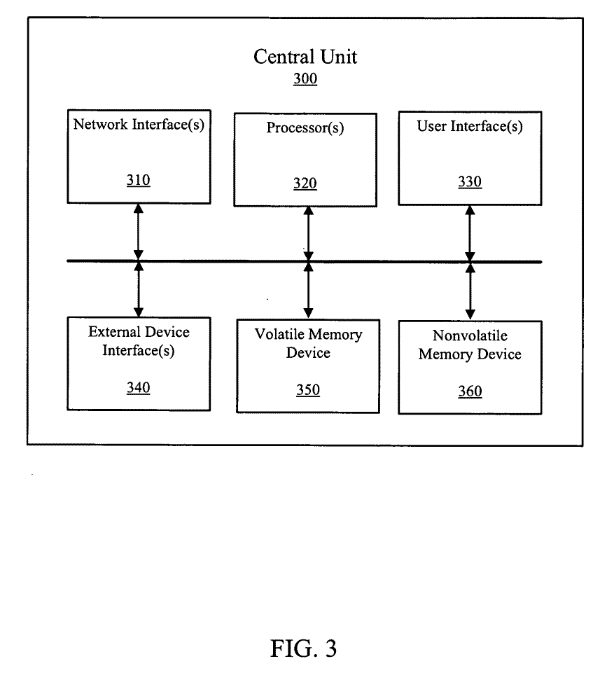

FIG. 3 is a block diagram of a central unit 300 in accordance with one embodiment of the present invention. The depicted central unit 300 includes a network interface 310, a processor 320, a user interface 330, an external device interface 340, a volatile memory device 350, and a nonvolatile memory device 360. In some embodiments, the central unit 300 corresponds to the central unit 150 of FIG. 1. In certain embodiments, the components of the central unit 300 may operate to detect seismic events and communicate seismic warning messages.

In certain embodiments, the network interface 310 may be configured to enable the central unit 300 to communicate with devices in a mobile communication network to which the central unit 300 corresponds. In some embodiments, the network interface 310 may be configured to enable the processor 320 to receive potential seismic event messages from wireless terminals (not shown) in one or more mobile telecommunications network (not shown). As mentioned previously, a potential seismic event messages may include a POSSIBLE_EARTHQUAKE_DETECTION (PED) message. Accordingly, the network interface 310 may facilitate accurate seismic event detection by enabling the central unit 300 to receive input for a large number of sources over a relatively short period of time.

In some embodiments, the network interface 310 and processor 320 may be configured to cooperate in replying to potential seismic event message with a reception confirmation message. In certain embodiments, a reception confirmation message may be configured to indicate to a wireless terminal that a potential seismic event message has been received. In some embodiments, the reception confirmation message may be made in accordance with a Automatic Repeat request (ARQ) operation. In some embodiments, transmitting a reception confirmation message to a wireless terminal may serve to enhance seismic event detection because a wireless terminal may transmit additional and more descriptive data to the central unit 300 after receiving confirmation that an initial potential seismic event message has been received.

In some embodiments, the processor 320 may be configured to perform an analysis of the potential seismic event messages upon which a determination will be made as to whether a seismic event actually occurred. In certain embodiments, the processor 320 may be configured to analyze message contents, number of messages, message arrival rates, and more. Similar to the analysis of sensor data by the wireless terminal 200, the processor 320 of the central unit 300 may analyze the potential seismic event messages using various combinations of analytical approaches, constraints, considerations and calculations.

In certain embodiments, the processor 320 may be configured to analyze potential seismic event messages using a strict series of predestinated series of analytical procedures that may include, for example, applying values corresponding to vibration wave frequencies and wavelengths to one or more calculation to produce a percentage. The resulting percentage may then be compared to a pre-selected level of confidence to determine whether a seismic event has occurred. Accordingly, the processor 320 may be configured to perform each of a sequence of analytical operations that maximize seismic event detection accuracy.

In other embodiments, the processor 320 may be configured analyze and detect seismic events using a more complex approach. For example, the processor 320 may execute a sequence of analytical operations that each increase or decrease a probability that is compared to an upper threshold and a lower threshold after the completion of each analytical operation. Similar to the analytical approach discussed above, if the processor 320 completes all of each operation in the analytical sequence without traversing either the upper or lower threshold, then the processor 320 may compare the calculated probability with a pre-selected level of confidence level to determine whether an actual seismic event has occurred. However, if at any point during the sequence of operations, the calculated probability traverses either the upper threshold or the lower threshold, then the processor 320 may immediately determine whether an actual seismic event has occurred without having to perform the remaining analytical operations in the sequence. Accordingly, the processor 320 it may be possible to increase efficiency by introducing additional constraints.

In other embodiments, a more dynamic analytical approach may be used to balance or optimize efficiency and accuracy. For example, in some embodiments, the upper threshold and lower threshold shift depending upon the number of analytical operations that have already been completed. So, for some embodiments, the upper and lower thresholds may be set very high and slowly decrease after each analytical operation in completed. In some embodiments, shifting the upper and lower thresholds according to the number of sequences performed may serve to increase efficiency, while not forfeiting an undesirable level of accuracy. Accordingly, the processor 320 may be configured to analyze potential seismic event messages using a variety of approaches, considerations, and calculations. It should be noted that the processor 320 of the central unit 300 may perform additional analytical operations that reflect the operations presented above with respect to the wireless terminal 200, and visa versa.

The user interface 330 may include one or more devices configured to enable communication between a user and the central unit 300. In certain embodiments, the user interface 330 may include a combination of interface devices such as a visual display device, a computer keyboard, a pointing device, a motion detector, an acoustic-to-electric transducer, and an electroacoustical transducer. Naturally, such interface devices may include or be accompanied by additional hardware and/or software configured to enable communication between a user and the central unit 300. Though the foregoing interface devices may be used to at least partially embody the user interface 330, the present invention is in no way limited to such devices. Indeed, the user interface 330 may include any device configured to enable communication between a user and a digital device. Accordingly, the user interface 330 of the present invention provides a flexible solution for enabling communication between users and the central unit 300.

In certain embodiments, the external device interface 340 may include any device configured to enable communication between the central unit 300 and one or more external devices. In some embodiments, the external device interface 340 may include an electrical connector or conductive device such as a modular connector, a serial port, or a Universal Serial Bus (USB) connector. For example, the external device interface 340 may include a USB port configured to receive a USB plug and thereby establish a connection between the central unit 300 and an external device. An external device may include any device configured to communicate with the central unit 300 via the external device interface 340.

For example, an external device may include peripheral devices such as printers, external or removable disk drives, tape drives, cameras, and so on. In certain embodiments, the external device interface 340 may provide a convenient and efficient solution updating seismic event detection software executed by the central unit 300 or disseminating seismic event detection data. Accordingly, the external device interface 340 may increase the overall utility of the present invention by providing a variety of flexible solutions.

In certain embodiments, the volatile memory device 350 is configured to provide a shorter-term data repository. In some embodiments, the volatile memory device 350 may include any variety of volatile storage mediums. For example, the volatile memory device 350 may include a device comprising a random access memory (RAM) component such as dynamic random access memory (DRAM), double data rate synchronous dynamic access memory (DDR SDRAM), static access memory (SRAM), and more. Though the foregoing may be used to embody the volatile memory device 350, the volatile memory device 350 is not limited to such embodiments. Accordingly, the volatile memory device 350 may provide a short-term data storage structure that functionally interacts with other components, such as the processor 320, to enhance seismic event detection operations as well as the overall utility and performance of the central unit 300.

In certain embodiments, the nonvolatile memory device 360 is configured to provide a long-term data repository. In some embodiments, the nonvolatile memory device 360 may include a variety nonvolatile storage mediums. For example, the nonvolatile memory device 360 may include any variety of a read-only memory (ROM) components such as a programmable read-only memory (PROM), a field programmable read-only memory (FPROM), an erasable programmable read-only memory (EPROM), or an electrically erasable programmable read-only memory (EEPROM). Additionally, the nonvolatile memory device 360 may store seismic activity data, previous analyses of seismic activity data, confidence level data, copies of potential seismic event messages, location data, copies of reception confirmation message, previously received seismic event warning messages, and more. Accordingly, the nonvolatile memory device 360 may provide a long-term data storage structure that functionally interacts with other components, such as the processor 320, or enhance seismic event detection operations as well as the overall utility and performance of the central unit 300.

As detailed above, a central unit 300 may be configured to receive and analyze potential seismic event messages from a large number of wireless terminals, determine whether a seismic event has occurred, and transmit seismic event warning messages to one or more destinations. Accordingly, the central unit 300 of the present invention may effectively contribute to a robust, accurate, and efficient seismic event detection solution.

It should be noted that some of the functional units described in this specification have been presented as a processor in order to more particularly emphasize their implementation independence. A processor may be implemented as a hardware circuit comprising custom VLSI circuits or gate arrays, off-the-shelf semiconductors such as logic chips, transistors, or other discrete components. Additionally, functions performed by a processor may be performed with the cooperation of other components described herein. For example, a processor may be configured to perform an operations described herein by executing one or more segments of code stored in a volatile or nonvolatile memory. Additionally, a processor may include multiple processors or processing devices depending upon the embodiment.

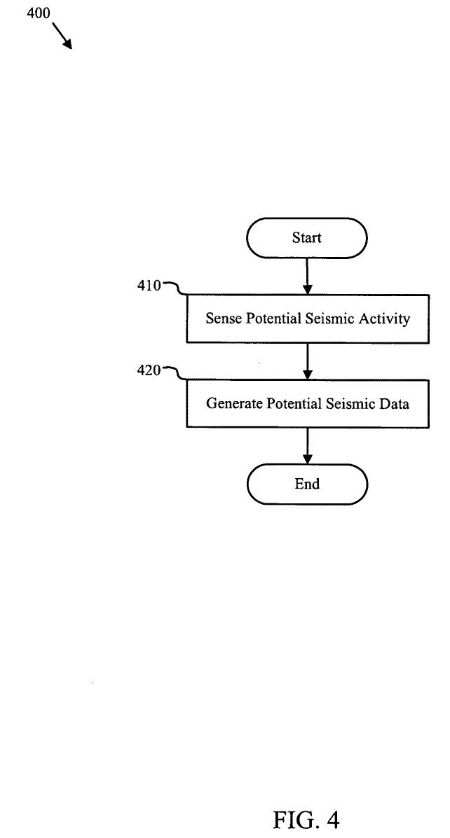

FIG. 4 is a flow chart diagram of a method 400 for generating potential seismic data in accordance with one embodiment of the present invention. The depicted method 400 includes sensing 410 seismic activity and generating 420 potential seismic data. In certain embodiments, the method 400 describes operations performed by a sensor, such as the seismic activity sensor 210 of FIG. 1. The method 400 provides a solution for generating potential seismic data.

The method 400 may begin with sensing potential seismic activity 410. In certain embodiments, sensing 410 potential seismic activity may include a seismic activity sensor detecting seismic forces resulting from an actual seismic event, such as an earthquake, or from a non-seismic event, such as a vibrating ring tone of a wireless terminal. After sensing 410 potential seismic activity, the method 400 may continue by generating 420 potential seismic data. Generating 420 potential seismic data may include a seismic activity sensor generating data corresponding to potential seismic activity. The potential seismic event may include a variety of data corresponding to the potential seismic event.

As depicted, in certain embodiments, this and subsequent methods (400-700) may only be performed in response to the sensing 410 of potential seismic activity. Consequently, some embodiments of the present invention may maximize a battery “life” of devices, such as a wireless terminal, configured to execute the method 400.

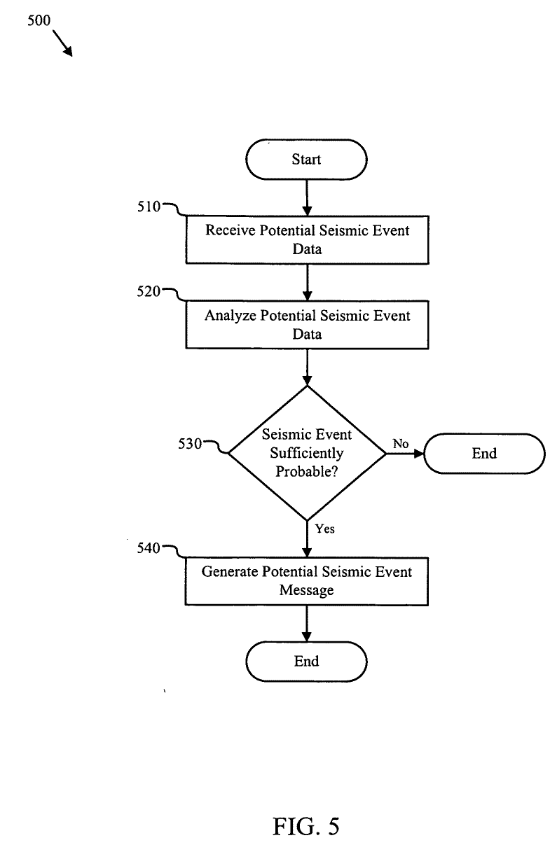

FIG. 5 is a flow chart diagram of a method 500 for generating a potential seismic event message in accordance with one embodiment of the present invention. The depicted method 500 includes receiving 510 potential seismic event data, analyzing 520 the potential seismic event data, determining whether a seismic event is sufficiently probable, and generating 540 a potential seismic event message. In certain embodiments, the method 500 may be performed, at least in part, by the processor 220 of FIG. 2. The method 500 provides a solution for generating a potential seismic event message that represents a potential seismic activity.

The method 500 begins by receiving 510 potential seismic event data. In certain embodiments, receiving 510 potential seismic event data may include a processor receiving potential seismic event data generated by local a seismic event sensor. In some embodiments, receiving 510 may include obtaining or retrieving data from a seismic event sensor. Seismic data may include any seismic data that would enhance the accuracy of detecting a seismic event. For example, the seismic data may include data representing a wave frequency, a wave amplitude, and/or a wavelength of the potential seismic activity sensed.

Upon receiving 510 potential seismic event data, the method 500 may continue by analyzing 520 the potential seismic event data and determining 530 whether the occurrence of an actual seismic event is sufficiently probable. The analyzing 520 and determining 530 may include a variety of statistical approaches, considerations, and calculations. For example, analyzing 520 may include one or more of the operations described above with respect to the processor 220 of FIG. 2 being configured to analyze potential seismic event data and determine whether the occurrence of an actual seismic event is sufficiently probable. Additionally, analyzing 520 may also include operations analogous to those described above with respect to the processor 530 of FIG. 3 being configured to analyze potential seismic event messages and determine whether an actual seismic event has occurred.

If it is determined 530 that a seismic event is not sufficiently probable, then the method 500 may end. However, if it is determined that a seismic event is sufficiently probable, then the method 500 may proceed by generating 540 a potential seismic event message to be transmitted to a central unit via a mobile communication network. Accordingly, the method 500 provides a solution for evaluating potential seismic event data to determine whether an actual seismic event is sufficiently probable, and, if so, generating potential seismic event messages corresponding to the seismic event. In some embodiments, the method 500 may be viewed as providing the benefit of detecting an eliminating “false positive” seismic events in addition to reporting probable seismic events.

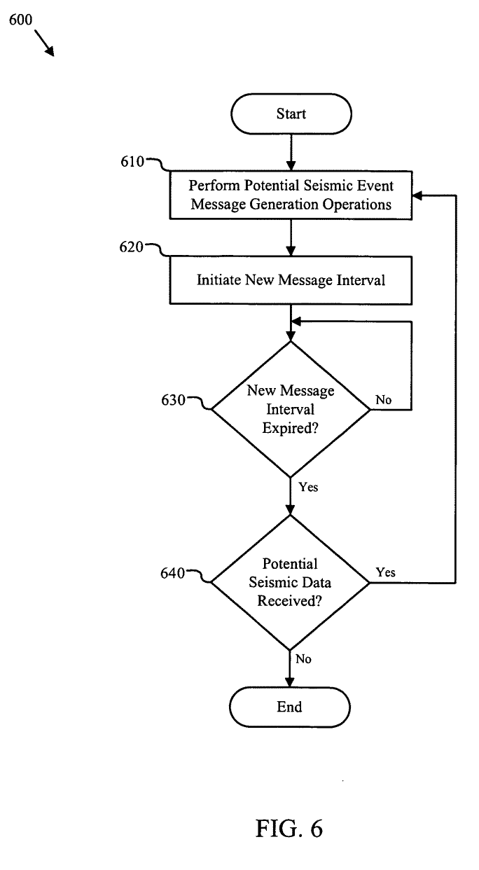

FIG. 6 is a flow chart diagram of a method 600 for generating an additional potential seismic event message in accordance with one embodiment of the present invention. The method 600 includes performing 610 potential seismic event message generation operations, initiating 620 a new message interval, determining 630 whether the new message interval has expired, and determining 640 whether potential seismic data has been received. In certain embodiments, the method 600 may be performed by the processor 220 of FIG. 2. The method 600 provides a solution for generating potential seismic event message that are temporally interspersed by a pre-selected interval.

The method 600 begins by performing 610 potential seismic event message generation operations. Performing 610 potential seismic event message generation operations may include the receiving 510, the analyzing 520, the determining 530, and the generating 540 of FIG. 5. Accordingly, in some embodiments, the method 600 may be executed or performed upon the completion of the method 500 of FIG. 5.

After a potential seismic event message is generated 610, the method 600 may continue by initiating 620 a new message interval. A new message interval may include a countdown of a pre-selected time interval. After initiating 620 the new message interval, the method 600 may continue by determining 630 whether the new message time interval has expired. Once the new message time interval has expired, the method 600 may continue by determining 640 if additional potential seismic data have been received.

If no more potential seismic data has been received, then the method 600 may discontinue. However, if more potential seismic data has been received, then the method 600 may again perform 610 the potential seismic event message operations on the new seismic event data. As described above, performing 610 the potential seismic event message generation operations may include operations similar to those depicted in FIG. 5 and described above. Accordingly, the method 600 of the present invention provides a solution for temporally spacing seismic event message operations by a pre-selected new message interval.

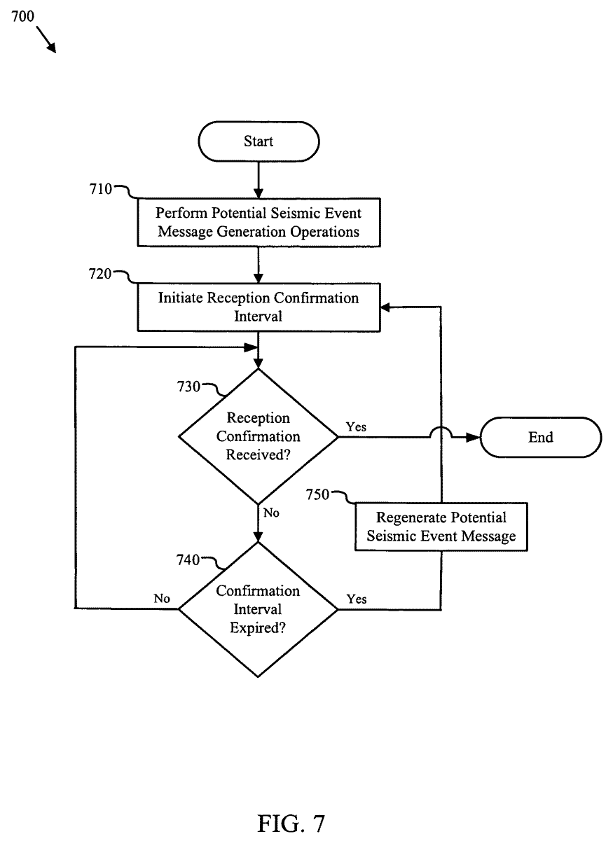

FIG. 7 is a flow chart diagram of a method 700 for confirming reception of a potential seismic event message in accordance with one embodiment of the present invention. The method 700 includes performing 710 potential seismic event generation operations, initiating 720 a reception confirmation interval, determining 730 whether a reception confirmation has been received, determining 740 whether the reception confirmation interval has expired, and regenerating 750 a potential seismic event message. In certain embodiments, the method 700 may be performed by the processor 220 of FIG. 2. The method 700 provides a solution for ensuring that a potential seismic event message has been received.

Similar to method 600 of FIG. 6 described above, the method 700 begins by performing 710 potential seismic event message generation operations. Performing 710 potential seismic event message generation operations may include the receiving 510, the analyzing 520, the determining 530, and the generating 540 of FIG. 5. Accordingly, in some embodiments, the method 700 may be executed or performed upon the completion of the method 500 of FIG. 5.

Upon performing 710 potential seismic event message operations, the method 700 may proceed by initiating 720 a reception confirmation interval. In certain embodiments, initiating 720 a reception confirmation interval may include beginning a countdown of a pre-selected duration that has been designated as a deadline for receiving a confirmation that a potential seismic event message has been received.

After initiating 720 the reception confirmation interval, the method 700 may continue by determining 730 whether a reception confirmation message has actually been received. In some embodiments, a reception confirmation message is sent from a central unit in response to receiving a potential seismic event message. If it is determined 730 that a reception confirmation message has been received, then the method 700 may end.

However, if it is determined 730 that a reception confirmation message has not been received, then the method 700 may continue by determining whether the reception confirmation interval has expired. If the reception confirmation interval has not expired, then the method 700 may determine 730 whether a reception confirmation message has been received in meantime. If, however, the reception confirmation interval has been received, then the method 700 may continue by regenerating the potential seismic event message to be again transmitted to, for example, a central unit. Accordingly, the method 700 provides a solution for ensuring that a potential seismic event message has been received.

As indicated above, the method 500 of FIG. 5, the method 600 of FIG. 6, and the method 700 of FIG. 7 may be performed by a processor, such as the processor 220 of FIG. 2. In certain embodiments, one or more of the operations of methods 500, 600, and 700 may be performed in combination with one or more operations of another one of methods 500, 600, and 700 to produce an additional method. So, for example, operations of method 600 and 700 could be combined to produce a method that provides for temporally spacing consecutive messages and ensuring that one or more of the messages is received. Consequently, the methods of the present invention are not limited to the embodiments depicted in FIG. 5, FIG. 6, and FIG. 7.

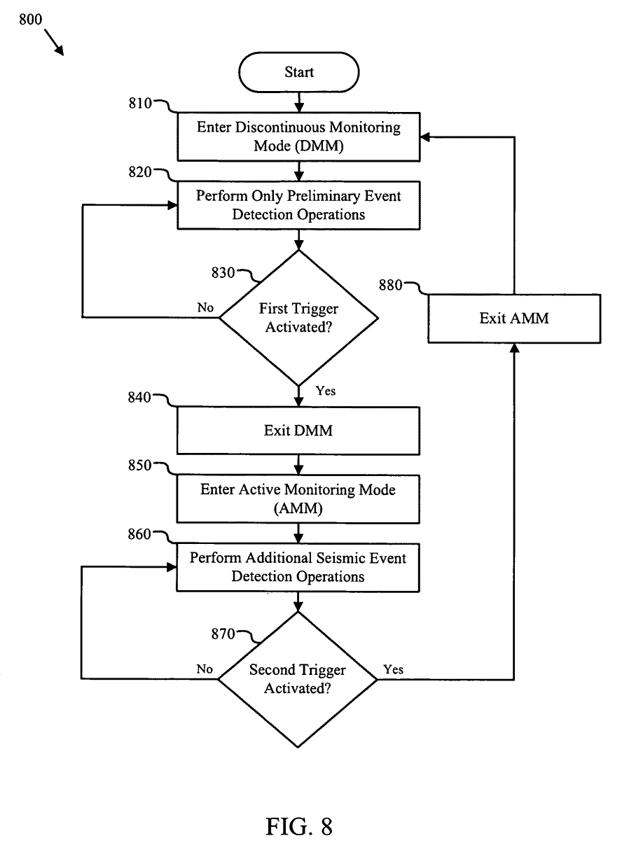

FIG. 8 is a flow chart diagram of a method 800 for a wireless terminal conserving power in accordance with one embodiment of the present invention. The depicted method 800 includes entering 810 discontinuous monitoring mode (DMM), performing 820 only preliminary seismic event detection operations, determining 830 whether a first trigger has been activated, exiting 840 DMM, entering 850 active monitoring mode (AMM), performing 860 additional seismic event detection operations, determining 870 whether a second trigger has been activated, and exiting 880 AMM. In certain embodiments, the operations of the method 800 are performed by a wireless terminal such as the wireless terminal 200 of FIG. 2. The operations 810-880 of the method 800 provide a solution for conserving power and/or extending a battery life of a wireless terminal by regulating an operational state of the wireless terminal.

In certain embodiments, entering 810 DMM may include a wireless terminal entering into a mode of operation that is relatively passive or less resource-intensive regarding battery power, processing capacity, and the like. In some embodiments, performing 820 only preliminary event detection operations may include a seismic activity sensor of a wireless terminal detecting seismic activity without performing one or more additional seismic event detection operations such as those disclosed in FIG. 4 to FIG. 7. Similarly, in some embodiments, performing 820 only preliminary event detection operations may include a processor of a wireless terminal receiving potential seismic event data from a seismic activity sensor without performing one or more additional seismic event detection operations. Accordingly, in certain embodiments, a wireless terminal may conserve power and extend batter life by entering into a “power save” or “sleep” mode when there is little or no need for more resource-intensive seismic event detection operations.

In some embodiments, determining 830 whether a first trigger has been activated may include determining whether a pre-selected scenario has occurred. A pre-selected scenario may include a variety of conditions such as a seismic activity sensor detecting seismic activity that exceeds a pre-selected threshold or perhaps a processor receiving potential seismic event data that exceeds a pre-selected threshold. If it is determined 830 that a first trigger has not been activated, then the method 800 may continue to perform 820 only preliminary event detection operations. However, if it is determined 830 that a first trigger has been activated, then the method 800 may proceed by exiting 840 the DMM.

Exiting 840 DMM may include a seismic event sensor and/or a processor leaving a “power save” or “sleep” mode of operation, where event detection operations are constrained to preliminary event detection operations. Entering 850 AMM may include commencing a mode of operation that enables or permits a processor to perform operations in addition to the preliminary event detection operations. It should be noted that, in certain embodiments, preliminary event detection operations may also be performed during AMM. Performing 860 additional seismic event detection operations may include performing operations such as analyzing potential seismic event data to determine whether an occurrence of a potential seismic event is sufficiently probable and/or generating a potential seismic event message. In certain embodiments, additional operations may be more resource-intensive than the preliminary event detection operations discussed above.

Similar to the determining 830 discussed above, determining 870 whether a second trigger has been activated may include a processor determining whether a pre-selected scenario has occurred. In certain embodiment, the pre-selected scenario may include a variety of conditions such as a condition where a seismic sensor has not detected seismic activity within a time period that begins from the last time that seismic activity was detected or potential seismic data was received. If it is determined 870 that a second trigger has not been activated, then the method 800 may continue to perform 860 additional seismic event detection operations. However, if it is determined 870 that a second trigger has been activated, then the method 800 may proceed by exiting 880 AMM.

Exiting AMM 880 may include preparing a processor and/or other wireless terminal components to enter a different mode of operation or monitoring. Upon exiting 880 AMM, the method 800 may continue by entering 810, or reentering, DMM 810. As mentioned above, entering 810 DMM may include a processor and/or other wireless terminal components commencing a mode of operation that conserves power by being less resource-intensive. In embodiments, where the wireless terminal does not rely on a battery, entering 810 DMM provides enables the wireless terminal to conserve resources such as processor capacity. In embodiments where the wireless terminal relies on a battery, entering 810 DMM provides the added benefit of enabling the wireless terminal to function for a longer period of time by extending the life of the battery. Accordingly, the method 800 provides one embodiment of the present invention where multiple monitoring modes may be implemented to enable an efficient use of wireless terminal resources.

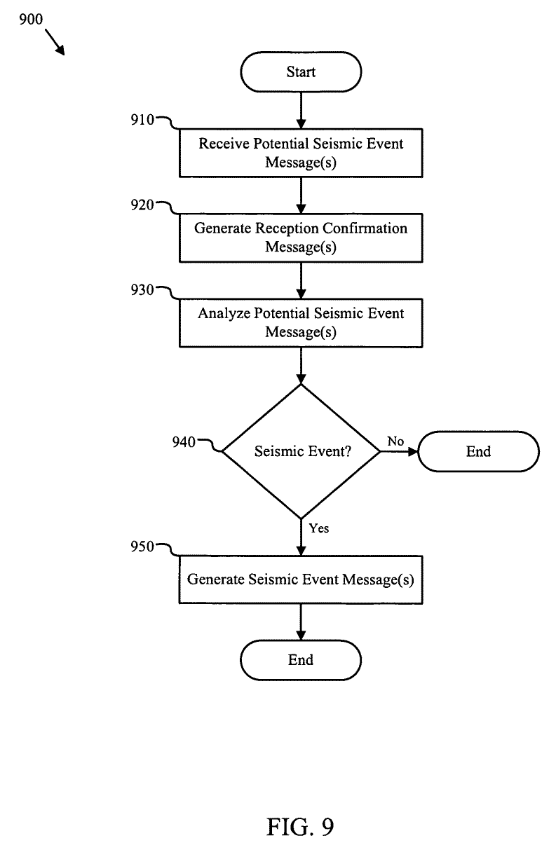

FIG. 9 is a flow chart diagram of a method 900 for detecting a seismic event in accordance with one embodiment of the present invention. The depicted method 900 includes receiving 910 potential seismic event messages, generating 920 reception confirmation messages, analyzing 930 potential seismic event messages, determining 940 whether a seismic event has occurred, and generating 950 seismic event messages. In certain embodiments, the method 900 may be performed by the processor 320 of FIG. 3. The method 900 provides a solution for detecting and reporting seismic events in accordance with the present invention.

The method 900 may begin by receiving 910 potential seismic event messages. In certain embodiments, receiving 910 potential seismic event message may include a central unit receiving a plurality of seismic event messages from one or more wireless terminals. As described above, a potential seismic event message may include a variety of data such as data descriptive of a potential seismic event sensed by a wireless terminal. Receiving 910 potential seismic event messages from a plurality of wireless terminals may increase the accuracy of detecting seismic events because of the remote chance that all wireless terminals in a give area will receive and transmit “false positive” data.

Once potential seismic event data has been received 910, the method 900 may continue by generating 920 reception confirmation messages. In certain embodiments, generating 920 reception confirmation messages may include an automated response to receiving a potential seismic event message from a wireless terminal. In certain embodiments, a reception confirmation message may correspond to a message defined by one or more pre-selected protocols. In certain embodiments, the generation 920 of reception confirmation messages may correspond to operations presented in FIG. 7 where a user terminal “listens” for a reception confirmation message upon transmitting a potential seismic event message. Accordingly, the method 700 may enhance reliability and efficiency of a seismic event detection system by responding to potential seismic event messages received from wireless terminals.

After generating 920 reception confirmation messages, the method 900 may continue by analyzing 940 the potential seismic event messages and determining 940 whether a seismic event has occurred. In certain embodiments, the analyzing 930 and determining 940 may include a variety of analytical approaches, considerations, and calculations. For example, the analyzing 930 and determining 940 of method 900 may include one or more of the operations described above with respect to the processor 320 of FIG. 3 being configured to analyze potential seismic event message to determine whether an actual seismic event has occurred.

Additionally, the analyzing 930 and determining 940 of method 900 may include one or more operations analogous to those described above with respect to the processor 220 of FIG. 2 being configured to analyze potential seismic event data and determine whether the occurrence of an actual seismic event is sufficiently probable. Accordingly, the method 900 may provide a plurality of approaches, considerations, and calculations to analyze 930 potential seismic event messages and determine 940 whether a seismic event has occurred.

If it is determined 940 that a seismic event has not occurred, then the method 900 may end. However, if it is determined 940 that a seismic event has occurred, then the method 900 may continue by generating 950 seismic event messages. Generating 950 seismic event messages may include producing a message descriptive of the seismic activity represented in the potential seismic event messages received 910. The seismic event warning messages may be generated so that each seismic event message is transmitted to one or more pre-selected destinations. Such destinations may include wireless terminals in a mobile communication network and or one or more additional destinations such as an Earthquake and Tsunami Warning System (ETWS). Accordingly, the method 900 provides a solution for warning and reporting seismic events detected by one or more wireless terminals.

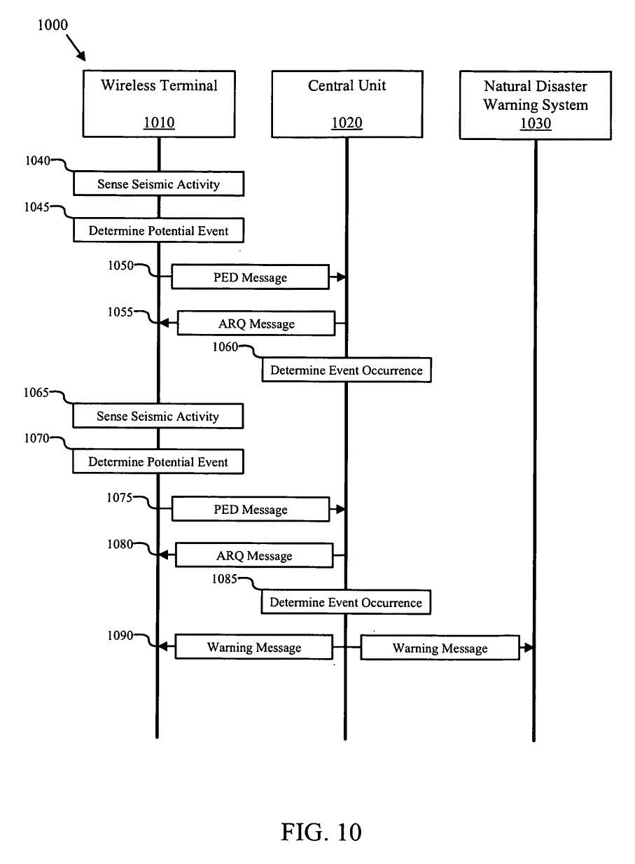

FIG. 10 is a sequence flow diagram of a system 1000 for detecting a seismic event in accordance with one embodiment of the present invention. The system 1000 includes a wireless terminal 1010, a central unit 1020, and a natural disaster warning system 1030. In certain embodiments, the system 1000 corresponds to the system 100 of FIG. 1. Additionally, the wireless terminal 1010 may correspond to the wireless terminal 200 of FIG. 2, and the central unit 1020 may correspond to the central unit 300 of FIG. 3. The system 1000 operates to detect and warn against seismic events.

In certain embodiments, the wireless terminal 1010 may sense 1040 potential seismic activity and determine 1045 whether a seismic event is sufficiently probable. The wireless terminal 1010 may then transmit 1050 a potential seismic event message to the central unit 1020. The potential seismic event message may be in the form of a PED message. It should be noted that the wireless terminal 1010 need not be 100% certain that an actual seismic activity has occurred. Rather, the wireless terminal need only determine that the occurrence of a seismic activity is sufficiently probable. As discussed below, the central unit 1020 may make the definitive determination as to whether an actual seismic event has occurred.

Upon receiving the potential seismic event message, the central unit 1020 may respond by transmitting 1055 a reception confirmation message to confirm to the wireless terminal 1010 that the potential seismic event message has been received. As depicted the reception confirmation message may be in the form of an ARQ message. In certain embodiments, had the central unit 1020 not transmitted 1055 a reception confirmation message to the wireless terminal 1010, the wireless terminal 1010 may be configured to retransmit the PED message.

The central unit 1020 may then determine 1060 whether an actual seismic event has occurred based on the PED message. In the depicted embodiment, the central unit 1020 does not take additional action because the central unit 1020 has determined 1060 that the PED message 1050 is a “false positive” and no seismic activity has actually occurred. However, also in the depicted embodiments, the wireless terminal 1010 senses 1065 additional seismic activity and determines 1070 that an actual seismic activity is sufficiently probable. Consequently, the wireless terminal 1010 transmits a potential seismic activity message in the form of a PED message 1075 and receives a reception confirmation message from the central unit 1020 in the form of an ARQ message 1080. Additionally, the central unit 1020 determines 1085 that an actual seismic event has occurred and then transmits warning messages 1090 to the wireless terminal 1010 and the natural disaster warning system. Accordingly, the system 1000 provides a sequence flow of operations for detecting and warning against seismic events.

One having ordinary skill in the art will readily understand that the invention as discussed above may be practiced with steps and/or operations in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

We claim:

1. A method, comprising:
receiving potential seismic data;
analyzing the potential seismic data;
determining whether an occurrence of an actual seismic event is sufficiently probable; and
generating a potential seismic event message to be transmitted to a mobile communication network.

2. The method of claim 1, wherein the generating of the potential seismic event comprises generating a reduced requirement message.

3. The method of claim 2, wherein the generating of the reduced requirement message comprises generating a message that requires a reduced amount of bandwidth to be transmitted to the mobile communication network.

4. The method of claim 2, wherein the generating of the reduced requirement message comprises generating a message in a manner that requires a reduced amount of battery usage.

5. The method of claim 1, further comprising:
entering a discontinuous monitoring mode;
determining whether a first trigger has been activated;
exiting the discontinuous monitoring mode and entering a active monitoring mode when the first trigger has been activated;
determining whether a second trigger has been activated;
exiting the active monitoring mode and entering the discontinuous monitoring mode when the second trigger has been activated.

6. The method of claim 1, wherein the generating of the potential seismic event message comprises indicating at least one characteristic of the potential occurrence of the seismic event.

7. The method of claim 1, wherein the potential seismic data is generated locally in response to sensing potential seismic activity.

8. The method of claim 1, wherein the determining of whether a potential seismic event has occurred comprises comparing the potential seismic data with example seismic data.

9. The method of claim 1, wherein the potential seismic event message is configured to be transmitted to a mobile communication network.

10. The method of claim 1, wherein the potential seismic event message is configured to be transmitted according to a high priority status.

11. The method of claim 1, wherein the generating of the potential seismic event message comprises executing error detection and correction operations to ensure the seismic event message is accurate.

12. The method of claim 1, further comprising:
initiating a reception confirmation interval;
determining whether a reception confirmation message has been received; and
determining whether the reception confirmation interval has expired; and
regenerating the potential seismic activity message when the reception confirmation message has not been received before the reception confirmation interval has expired.

13. The method of claim 1, further comprising:
initiating a new message interval;
after expiration of a pre-selected interval,
receiving additional seismic data;
analyzing the additional seismic data; and
generating an additional potential seismic event message.

14. An apparatus, comprising:
a processor configured to
receive potential seismic data;
analyze the potential seismic data;
determine whether an occurrence of an actual seismic event is sufficiently probable; and
generate a potential seismic event message to be transmitted to a mobile communication network.

15. The apparatus of claim 14, wherein the processor is configured to generate the potential seismic event message by generating a reduced requirement message.

16. The apparatus of claim 15, wherein the reduced requirement message comprises a message that requires a reduced amount of bandwidth to be transmitted to the mobile communication network.

17. The apparatus of claim 15, wherein the reduced requirement message comprises a message generated using a reduced amount of battery usage.

18. The apparatus of claim 14, wherein the processor is further configured to
enter a discontinuous monitoring mode;
determine whether a first trigger has been activated;
exit the discontinuous monitoring mode and enter a active monitoring mode when the first trigger has been activated;
determine whether a second trigger has been activated;
exit the active monitoring mode and enter the discontinuous monitoring mode when the second trigger has been activated.

19. The apparatus of claim 14, wherein the processor is configured to generate the potential seismic event message by indicating at least one characteristic of the potential occurrence of the seismic event.

20. The apparatus of claim 14, wherein the potential seismic data is generated locally in response to sensing potential seismic activity.

21. The apparatus of claim 14, wherein the potential seismic data is generated locally by a seismic event sensor.

22. The apparatus of claim 14, wherein the processor is configured to determine whether a potential seismic event has occurred by comparing the seismic data with example seismic data.

23. The apparatus of claim 14, wherein the potential seismic event message is configured to be transmitted to a mobile communication network.

24. The apparatus of claim 14, wherein the potential seismic event message is configured to be transmitted according to a high priority status.

25. The apparatus of claim 14, wherein the processor is configured to generate the potential seismic event message by executing error detection and correction operations to ensure the seismic event message is accurate.

26. The apparatus of claim 14, wherein the processor is configured to initiate a reception confirmation interval, determine whether a reception confirmation message has been received, determine whether the reception confirmation interval has expired, and regenerate the potential seismic activity message when the reception confirmation message has not been received before the reception confirmation interval has expired.

27. The apparatus of claim 14, wherein the processor is configured to receive additional seismic data, analyze the additional seismic data, and generate an additional potential seismic event message, after expiration of a pre-selected interval.

28. The apparatus of claim 14, wherein the apparatus comprises a wireless terminal.

29. A computer program embodied on a computer-readable medium, the computer program configured to control a processor to perform operations comprising:
receiving potential seismic data;
analyzing the potential seismic data;
determining whether an occurrence of an actual seismic event is sufficiently probable; and
generating a potential seismic event message to be transmitted to a mobile communication network.

30. An apparatus, comprising:
receiving means for receiving potential seismic data;
analyzing means for analyzing the potential seismic data;
determining means for determining whether an occurrence of an actual seismic event is sufficiently probable; and
generating means for generating a potential seismic event message to be transmitted to a mobile communication network.

31. A method, comprising:
receiving a potential seismic event message from a wireless terminal;
analyzing the potential seismic event message;
determining whether a seismic event has occurred; and
generating a seismic event message.

32. The method of claim 31, wherein the seismic event message is transmitted to the wireless terminal and to an earthquake and tsunami warning system.

33. The method of claim 30, wherein the receiving of the potential seismic event message occurs in response to the wireless terminal sensing the seismic event.

34. The method of claim 30, wherein the analyzing of the seismic event message comprises comparing the potential seismic event message to a potential seismic event message received from another wireless terminal.

35. An apparatus, comprising:
a processor configured to
receive a potential seismic event message from a wireless terminal;
analyze the potential seismic event message;
determine whether a seismic event has occurred; and
generate a seismic event message.

36. The apparatus of claim 34, wherein the seismic event message is transmitted to the wireless terminal and to an earthquake and tsunami warning system.

37. The apparatus of claim 34, wherein the processor is configured to receive the potential seismic event message in response to the wireless terminal sensing the seismic event.

38. The apparatus of claim 34, wherein the processor is configured to analyze the potential seismic event message by comparing the seismic event message to a potential seismic event message received from another wireless terminal.

39. A computer program embodied on a computer-readable medium, the computer program configured to control a processor to perform operations comprising:
receiving a potential seismic event message from a wireless terminal;
analyzing the potential seismic event message;
determining whether a seismic event has occurred; and
generating a seismic event message.

40. An apparatus, comprising:
receiving means for receiving a potential seismic event message from a wireless terminal;
analyzing means for analyzing the potential seismic event message;
determining means for determining whether a seismic event has occurred; and
generating means for generating a seismic event message.

41. A system, comprising:
a wireless terminal configured to
receive potential seismic data,
analyze the potential seismic data,
determine whether an occurrence of an actual seismic event is sufficiently probable, and
generate a potential seismic event message configured to indicate a potential occurrence of a seismic event; and
a central unit configured to
receive the potential seismic event message from the wireless terminal,
analyze the potential seismic event message,
determine whether a seismic event has occurred, and
generate a seismic event message.
